(19) United States
(12) Patent Application Publication
(10) Pub. No.: US 2014/0353914 A1
(43) Pub. Date: Dec. 4, 2014

(54) Seal with Replaceable Sealing Member

(71) Applicant: Aktiebolaget SKF, Goteborg (SE)

(72) Inventor: Yefim Epshetsky, Schaumburg, IL (US)

(21) Appl. No.: 13/906,420

(22) Filed: May 31, 2013

(51) Int. Cl. F16J 15/32

(52) U.S. Cl. CPC F16J 15/32
USPC 277/300; 277/500

(57) ABSTRACT

In described embodiments, a seal assembly for sealing a space between a shaft and a housing is provided. The shaft has a shaft centerline. The seal assembly has an outer portion connectable to the housing and an inner portion extending radially inwardly from the outer portion toward the shaft. The inner portion has a generally concave cavity. A generally annular sealing member is releasably inserted into the cavity. The sealing member has a shaft contact surface engageable with the shaft. A method of removing and replacing the sealing member is also provided.

### BACKGROUND OF THE INVENTION

1. Field of the Invention

The present invention relates to seals, and more particularly to radial seals for sealing a space about the rotatable shaft.

2. Description of the Related Art

Radial shaft seals are generally known and typically include a seal member with an inner circumferential contact point, or “sealing surface”, which may be provided by an annular lip or a cylindrical portion of the seal case, that is engageable with the exterior surface of a shaft. As the shaft rotates within the seal, the sealing surface remains in sliding contact with the shaft outer surface to prevent the migration of substances (e.g., oil, debris particles) through a sealed space.

As a result of use, however, the sealing surface eventually wears, resulting in the replacement of the entire shaft seal. Seal replacement can be a time-consuming and costly task, requiring the shaft around which the seal operates to be shut down for an extended period of time while the old seal is removed and the new seal is installed. It would be beneficial to have a seal that provides the ability to replace only the sealing surface, thereby reducing the time and expense for such maintenance.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a seal assembly for sealing a space between a shaft and a housing. The shaft has a shaft centerline. The seal assembly has an outer portion connectable to the housing and an inner portion extending radially inwardly from the outer portion toward the shaft. The inner portion has a generally concave cavity. A generally annular sealing member is releasably inserted into the cavity. The sealing member has a shaft contact surface engageable with the shaft.

In another embodiment, the present invention is a seal assembly. The seal assembly comprises an outer portion and an inner portion extending radially inwardly from the outer portion. The inner portion has a generally concave cavity. A generally annular sealing member is releasably inserted into the cavity. The sealing member has a shaft contact surface.

In yet another embodiment, the present invention is a method of replacing a sealing member on a sealing assembly. The method comprises the steps of providing a seal assembly on a shaft. The seal assembly has an outer portion having an inner portion extending therefrom. The inner portion has a generally concave cavity. A generally annular sealing member is releasably inserted into the cavity. The sealing member has a shaft contact surface. The method further comprises the steps of biasing the inner portion away from the shaft; rolling the sealing member along the shaft; removing the sealing member from the shaft; sliding a replacement sealing member onto the shaft toward the concave cavity; and releasing the inner portion, allowing the concave cavity to engage and retain the sealing member at a desired location along the shaft.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 shows a side elevational view, partially in section, of a seal assembly according to a first exemplary embodiment of the present invention;

FIG. 2 shows a side elevational view, partially in section, of a seal assembly according to a second exemplary embodiment of the present invention; and

FIG. 3 shows an enlarged portion of the sealing member used in the seal assembly shown in FIG. 2.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

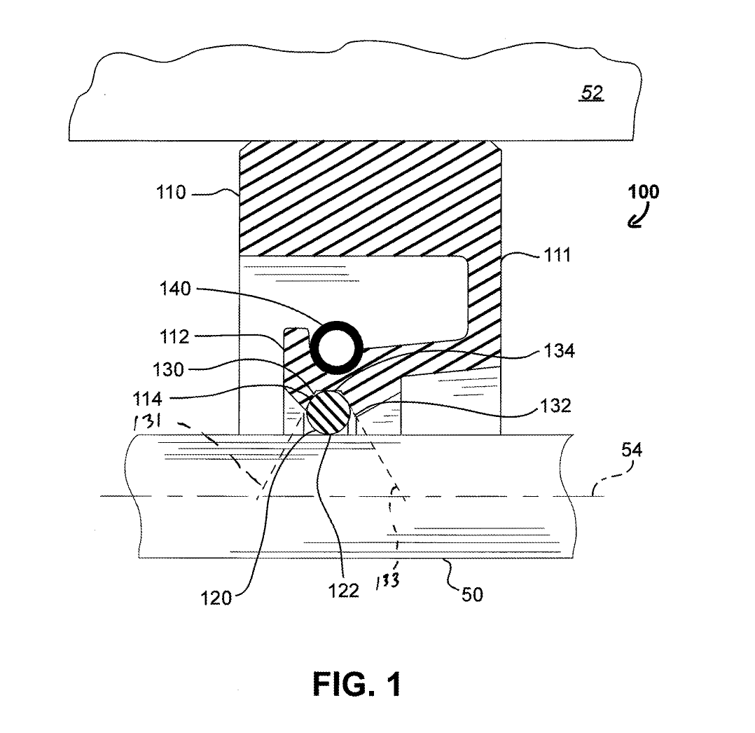

Referring to FIG. 1, a seal assembly 100 according to a first exemplary embodiment of the present invention is shown. Seal assembly 100 is used for sealing a space between a shaft 50 and a housing 52. Seal assembly 100 circumferentially surrounds shaft 50 and is co-axial with a shaft centerline 54.

For ease of view, only shaft 50 and a portion of seal assembly 100 that extends above shaft 50 as shown in FIG. 1 is shown. Seal assembly 100 is shown in cross-section, while shaft 50 and housing 52 are not.

Seal assembly 100 includes an outer portion 110 that is connectable with housing 52. Outer portion 110 has a radially inwardly extending portion 111 and an inner portion 112 extending radially inwardly therefrom. In an exemplary embodiment, both outer portion 110 and inner portion 112 may be constructed from a metal or other rigid material.

Inner portion 112 extends generally parallel to shaft 50 and inner portion 112 has a generally concave radial cavity 114 facing shaft 50.

A generally annular sealing member 120 is releasably inserted into cavity 114. As shown in FIG. 1, sealing member 120 has a generally circular cross-section. Sealing member 120 has an inner circumferential sealing surface 122 engageable with shaft 50. Sealing surface 122 is the only portion of seal assembly 100 that contacts shaft 50.

Concave cavity 114 has a first sidewall 130, a second sidewall 132, and a base 134 extending between first sidewall 130 and second sidewall 132. As shown by the dashed lines extending downward from sidewalls 130, 132 in FIG. 1, sidewalls 130, 132 extend in directions that intersect shaft 50 at oblique angles relative to shaft centerline 54. Sealing member 120 engages each of first sidewall 130, second sidewall 132, and base 134.

A generally annular biasing member 140 is disposed about a portion of inner portion 112. Biasing member 140 may be a garter spring, which is known in the art. Biasing member 140 is configured to exert a biasing force directed generally radially inwardly toward shaft 50 such that inner portion 112 exerts a contact pressure on shaft 50.

As sealing surface 122 is worn down as a result of friction between sealing surface 122 and shaft 50, the pressure exerted by biasing member 140 decreases, reducing the effectiveness of sealing member 120 and requiring sealing member 120 to be removed from outer portion 110 and replaced with a new sealing member (not shown). Because sealing member 120 is releasably inserted into cavity 114, sealing member 120 is easily removed from inner portion 112 and replaced with the new sealing member, without having to remove entire seal assembly 100 from housing 52.

To remove and replace sealing member 120, inner portion 112 is biased away from shaft 50. Downwardly extending portion 111 of outer portion 110 allows inner portion 112 to generally pivot about an intersection between downwardly extending portion 111 and inner portion 112, allowing inner portion 112 to be lifted sufficiently away from shaft 50 to allow access to sealing member 120. Sealing member 120 may be rolled along shaft 50 and removed from shaft 50.

A replacement sealing member 120 may then be inserted over shaft 50 and rolled along shaft 50 to seal assembly 100. Inner portion 112 is lifted sufficiently away from shaft 50 to allow replacement sealing member 120 to be rolled in line with concave cavity 114. Inner portion 112 is released, allowing concave cavity 114 to engage and retain sealing member 120 at its desired location along shaft 50.

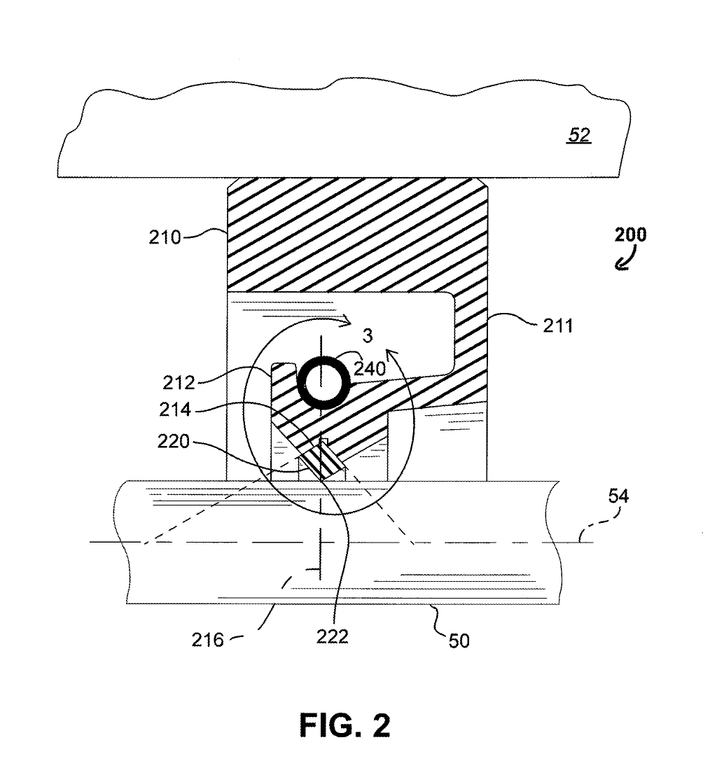

Referring now to FIG. 2, a seal assembly 200 according to a second exemplary embodiment of the present invention is shown. Similar to seal assembly 100, seal assembly 200 is used for sealing a space between shaft 50 and housing 52. Further, as shown in FIG. 2, seal assembly 200 is shown in cross-section, while shaft 50 and housing 52 are not.

Seal assembly 200 includes an outer portion 210 that is connectable with housing 52. Outer portion 210 has a radially inwardly extending portion 211 and an inner portion 212 extending radially inwardly therefrom. In an exemplary embodiment, both outer portion 210 and inner portion 212 may be constructed from a metal or other rigid material.

Inner portion 212 extends generally parallel to shaft 50 and inner portion 212 has a generally concave radial cavity 214 facing shaft 50. A generally annular sealing member 220 is releasably inserted into cavity 214. As shown in FIG. 2, sealing member 220 has a generally parallelogram cross-section. Sealing member 220 also has a shaft contact surface, or shaft sealing point, 222 that extends along a radial plane 216.

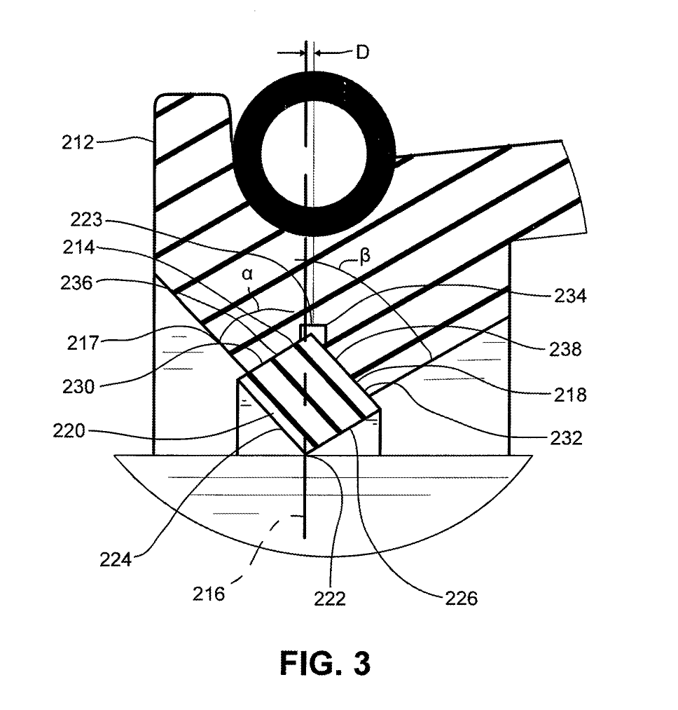

Referring to FIG. 3, inner portion 212 has a first surface 217 extending in a first angle α relative to radial plane 216 and a second surface 218 extending in a second angle β relative to radial plane 216. As shown by the dashed lines extending downward from first surface 217 and second surface 218 in FIG. 2, first surface 217 and second surface 218 extend in directions that intersect shaft 50 at oblique angles relative to shaft centerline 54. In an exemplary embodiment, first angle α is not equal to second angle β.

Sealing member 220 has a first sealing surface 224 extending along the first angle α relative to radial plane 216 such that first sealing surface 224 is generally parallel to second surface 218. Additionally, sealing member 220 has a second sealing surface 226 extending along the second angle β relative to radial plane 216 such that second sealing surface 226 is generally parallel to first surface 217. Shaft sealing point 222 is between first sealing surface 224 and second sealing surface 226. Shaft sealing point 222 is the only portion of seal assembly 200 that contacts shaft 50. Because sealing member 220 is annularly shaped, shaft sealing point 222 extends around the circumference of shaft 50 along radial plane 216.

Concave cavity 214 includes a first sidewall 230, a second sidewall 232, and a niche 234 formed between first sidewall 230 and second sidewall 232. Niche 234 is offset from radial plane 216 by a distance “D”.

A seating point 223 of sealing member 220 is disposed within niche 234 so that side surfaces 236, 238 of sealing member 220 engage first surface 217 and second surface 218, respectively, of concave cavity 214 to seat sealing member 220 within cavity to 114. Seating point 223 is diametrically opposed from shaft sealing point 222.

Referring still to FIG. 3, a generally annular biasing member 240 is disposed about a portion of inner portion 212 and has a center line extending in the same radial plane as niche 234. As discussed above with respect to biasing member 140, biasing member 240 may be a garter spring. Biasing member 240 is configured to exert a biasing force directed generally radially inwardly toward radial plane 216 such that inner portion 212 exerts a contact pressure on shaft 50. A centerline of annular biasing member 240 therefore is offset from radial plane 216 by the distance “D”. The distance “D” provides a moment arm that presses shaft sealing point 222 against shaft 50.

Similar to seal assembly 100, as shaft sealing point 222 is worn down as a result of friction between shaft sealing point 222 and shaft 50, the pressure exerted by biasing member 240 decreases, reducing the effectiveness of sealing member 220 and requiring sealing member 220 to be removed from inner portion 212 and replaced with a new sealing member (not shown). Because sealing member 220 is releasably inserted into cavity 214, sealing member 220 is easily removed from inner portion 212 and replaced with the new sealing member, without having to remove entire seal assembly 200 from housing 52.

Replacement of sealing member 220 is similar to that of replacing sealing member 120 as discussed above. However, due to the fact that sealing member 220 has a parallelogram cross-section, as opposed to the circular cross-section of sealing member 120, rolling sealing member 220 along shaft 50 for removal and replacement of new sealing number 220 may be a bit more difficult. Additionally, it is desired that sealing surfaces 224, 226 are aligned such that shaft sealing point 222 engages shaft 50 so that sealing member 220 is properly seated within cavity 214.

It will be further understood that various changes in the details, materials, and arrangements of the parts which have been described and illustrated in order to explain the nature of this invention may be made by those skilled in the art without departing from the scope of the invention as expressed in the following claims.

1. A seal assembly for sealing a space between a shaft and a housing, the seal assembly comprising:
an outer portion connectable to the housing;
an inner portion extending radially inwardly from the outer portion toward the shaft, the inner portion having a generally concave cavity; and
a generally annular sealing member releasably inserted into the cavity, the sealing member having a shaft contact surface engageable with the shaft.

2. The seal assembly according to claim 1, wherein the sealing member has a generally circular cross-section.

3. The seal assembly according claim 2, wherein the generally concave cavity has a first sidewall, a second sidewall, and a base extending between the first sidewall and the second sidewall, wherein the sealing member engages each of the first sidewall, the second sidewall, and the base.

4. The seal assembly according claim 1, wherein the sealing member has a generally parallelogram cross-section.

5. The seal assembly according to claim 4, wherein the generally concave cavity comprises a first sidewall, a second sidewall, and a niche formed between the first sidewall and the second sidewall.

6. The seal assembly according claim 5, wherein the sealing member comprises a seating point disposed within the niche.

7. The seal assembly according to claim 1, wherein the cavity comprises a first surface extending along a first direction at an angle oblique to the shaft centerline and a second surface extending along a second direction at an angle oblique to the shaft centerline.

8. The seal assembly according to claim 7, wherein the sealing member has a first sealing surface extending along the first angle and a second sealing surface extending along the second angle.

9. The seal assembly according to claim 8, wherein the sealing member includes a sealing zone between the first sealing surface and the second sealing surface.

10. The seal assembly according to claim 1, wherein the shaft contact surface comprises a sealing zone.

11. The seal assembly according to claim 1, further comprising a generally annular biasing member disposed about the inner portion, the biasing member disposed radially over the sealing member, the biasing member being configured to exert a biasing force directed generally radially inwardly toward the shaft such that the inner portion exerts a contact pressure on the shaft.

12. The seal assembly according to claim 11, wherein the generally annularly biasing member is offset a defined distance from a radial plane defined by the shaft contact surface.

13. A seal assembly comprising:
an outer portion;
an inner portion extending radially inwardly from the outer portion, the inner portion having a generally concave cavity; and
a generally annular sealing member releasably inserted into the cavity, the sealing member having a shaft contact surface.

14. The seal assembly according to claim 13, wherein the sealing member has a generally circular cross-section.

15. The seal assembly according to claim 13, wherein the sealing member has a generally parallelogram cross-section.

16. The seal assembly according to claim 15, wherein the sealing member comprises a first sealing surface, a second sealing surface, and a sealing point between the first sealing surface and the second sealing surface.

17. The seal assembly according to claim 16, wherein the generally concave cavity comprises a first sidewall, a second sidewall, and a niche formed between the first sidewall and the second sidewall.

18. The seal assembly according to claim 17, wherein the sealing member further comprises a seating point disposed within the niche.

19. The seal assembly according to claim 13, wherein the shaft contact surface comprises a sealing zone.

20. (canceled)

21. The seal assembly according to claim 1, wherein the sealing member extends longitudinally wholly between the first frustoconical sidewall and the second frustoconical sidewall.
